(19) United States
(12) Patent Application Publication
(10) Pub. No.: US 2025/0119624 A1
(43) Pub. Date: Apr. 10, 2025

(54) VIDEO GENERATION USING FRAME-WISE TOKEN EMBEDDINGS

(71) Applicant: ADOBE INC., SAN JOSE, CA (US)

(72) Inventors: Seoung Wug Oh, San Jose, CA (US); Mingi Kwon, San Jose, CA (US); Joon-Young Lee, San Jose, CA (US); Yang Zhou, Mountain View, CA (US); Difan Liu, San Jose, CA (US); Haoran Cai, Mercer Island, WA (US); Baqiao Liu, Champaign, IL (US); Feng Liu, Beaverton, OR (US)

(21) Appl. No.: 18/894,443

(22) Filed: Sep. 24, 2024

Related U.S. Application Data
(60) Provisional application No. 63/588,424, filed on Oct. 6, 2023.

(51) Int. Cl. H04N 21/81

(52) U.S. Cl. CPC H04N 21/816

(57) ABSTRACT

A method, apparatus, non-transitory computer readable medium, and system for generating synthetic videos includes obtaining an input prompt describing a video scene. The embodiments then generate a plurality of frame-wise token embeddings corresponding to a sequence of video frames, respectively, based on the input prompt. Subsequently, embodiments generate, using a video generation model, a synthesized video depicting the video scene. The synthesized includes a plurality of images corresponding to the sequence of video frames.

### CROSS-REFERENCE TO RELATED APPLICATION

This U.S. non-provisional application claims priority under 35 U.S.C. § 119 to U.S. Provisional Patent Application No. 63/588,424, filed on Oct. 6, 2023, in the United States Patent and Trademark Office, the disclosure of which is incorporated by reference herein in its entirety.

### BACKGROUND

The following relates generally to image processing, and more specifically to video generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. In some cases, image generation models can be used to create synthetic videos by generating images that make up frames of the video. However, there are challenges associated with simply stitching generated images together, such as ensuring consistency across frames and ensuring sufficiently diverse content over time.

### SUMMARY

Embodiments of the present inventive concepts include systems and methods for generating synthetic videos. Embodiments include a video generation model and a frame-wise token generator. The video generation model includes temporal layers that ensure temporal coherence between generated frames. The frame-wise token generator generates additional tokens that are appended to a text embedding to induce variation across the frames while maintaining temporal coherence. For example, the frame-wise token generator results in videos that have more diverse movements than videos generated without the frame-wise tokens. Some embodiments of the video generation model adapt an image generation model by finetuning the image generation model with regularization losses, introducing a mapping layer to ensure temporal coherence between noisy latents, and guiding inference using mitigating gradient sampling. Additional details regarding these techniques will be described further down.

A method, apparatus, non-transitory computer readable medium, and system for video generation are described. One or more aspects of the method, apparatus, non-transitory computer readable medium, and system include obtaining an input prompt describing a video scene; generating a plurality of frame-wise token embeddings corresponding to a sequence of video frames, respectively, based on the input prompt; and generating, using a video generation model, a synthesized video depicting the video scene, wherein the synthesized video comprises a plurality of images corresponding to the sequence of video frames.

A method, apparatus, non-transitory computer readable medium, and system for video generation are described. One or more aspects of the method, apparatus, non-transitory computer readable medium, and system include obtaining a training set comprising a video and a training prompt describing the video; computing a temporal consistency loss based on the video and the training prompt; and training a video generation model to generate a synthesized video from an input prompt based on the temporal consistency loss.

An apparatus, system, and method for video generation are described. One or more aspects of the apparatus, system, and method include at least one processor; at least one memory including instructions executable by the at least one processor; and a video generation model comprising parameters stored in the at least one memory and trained to generate a synthesized video based on an input prompt, wherein the video generation model includes a mapping network configured to generate a plurality of regularized noise inputs based on a plurality of noise inputs, respectively, and wherein the plurality of regularized noise inputs have a temporally regularized distribution.

### BRIEF DESCRIPTION OF THE DRAWINGS

FIG. 1 shows an example of a video processing system according to aspects of the present disclosure.

FIG. 2 shows an example of a video processing apparatus according to aspects of the present disclosure.

FIG. 3 shows an example of a frame-wise token generator according to aspects of the present disclosure.

FIG. 4 shows an example of a guided latent diffusion model according to aspects of the present disclosure.

FIG. 5 shows an example of a U-Net according to aspects of the present disclosure.

FIG. 6 shows an example of results using frame-wise tokens according to aspects of the present disclosure.

FIG. 7 shows an example of a method a diffusion process according to aspects of the present disclosure.

FIG. 8 shows an example of a method for generating synthesized video according to aspects of the present disclosure.

FIG. 9 shows an example of a machine learning training algorithm according to aspects of the present disclosure.

FIG. 10 shows an example of a diffusion model training algorithm according to aspects of the present disclosure.

FIG. 11 shows an example of a method for regularizing the training of a video generation model according to aspects of the present disclosure.

FIG. 12 shows an example of a first pipeline for training a video generation model according to aspects of the present disclosure.

FIG. 13 shows an example of a second pipeline for training a video generation model according to aspects of the present disclosure.

FIG. 14 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

Some conventional approaches for text-to-image generation include Generative Adversarial Networks (GANs), which have demonstrated impressive performance in generating realistic images from text prompts. However, GANs face challenges such as training instability and poor generalizability. Recent advancements in diffusion models have shown promise in generating high-quality images from text prompts. The text-to-image diffusion models incorporate a pre-trained text encoder that is configured to generate a text embedding from an input text, and features of the text embedding are combined with the intermediate image features during image synthesis using cross-attention.

Video generation, also known as text-to-video (T2V), is a recent application of generative models. Some approaches involve adapting text-to-image (T2I) models for video generation by adding temporal attention mechanisms and 3D convolutions, and then retraining the entire set of parameters. This can diminish the variety of styles that the models can produce, as the training data represents only highly realistic videos. Further, such methods may require multi-stage training, which involves generating keyframes and performing spatial or temporal interpolation. Other approaches involve training a subset of the model parameters, while keeping the majority of the parameters from a parent image generation model fixed to preserve its knowledge. However, while this can reduce training complexity, the existing finetuning processes are still multi-staged and extensive, and the results still lack diversity.

Embodiments of the present inventive concepts improve both the efficiency of training video generation models and the quality and diversity of the output videos. A frame-wise token generator of the present embodiments provides an additional, learnable condition that results in more diverse outputs as compared to a constant text condition for every frame. Some embodiments additionally include a mapping layer that adjusts the noise distribution to be more temporally coherent. Embodiments improve the training process by introducing regularization losses, such as self-attention losses that use the attention maps of the video generation model and decoupled contrastive losses that use deep features from the model. Additionally, some embodiments guide the video generation model at inference time by using mitigating gradient sampling to adjust the denoising process to iteratively reduce the differences between generated frames.

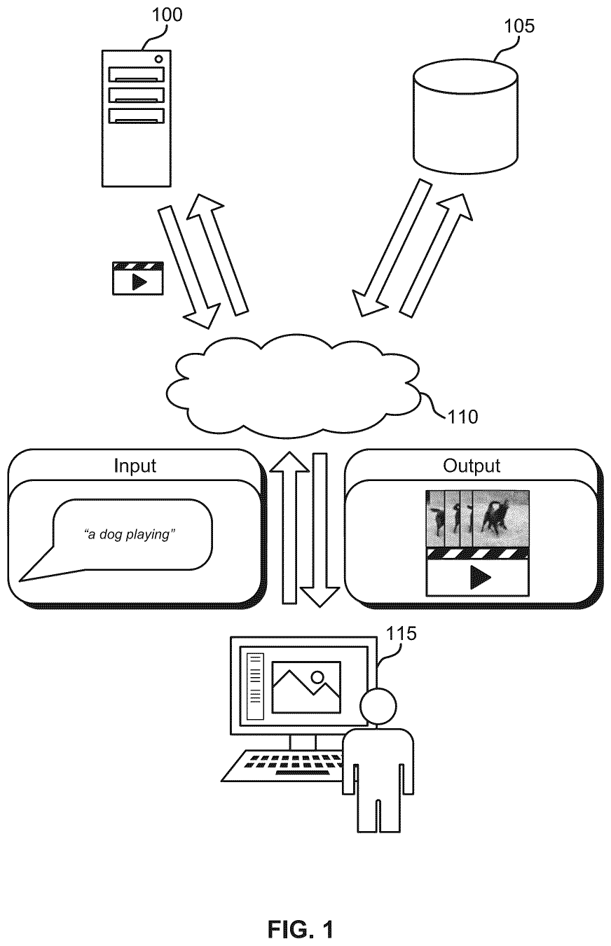

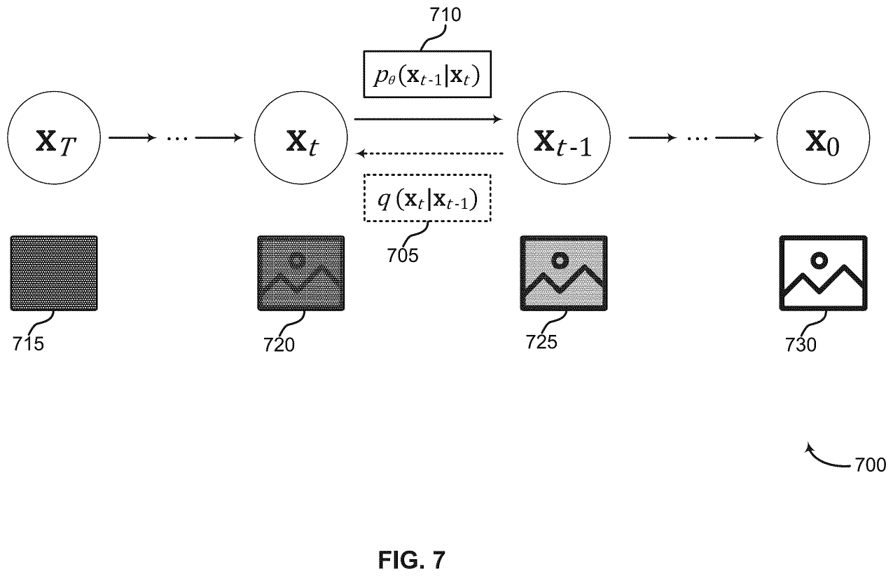

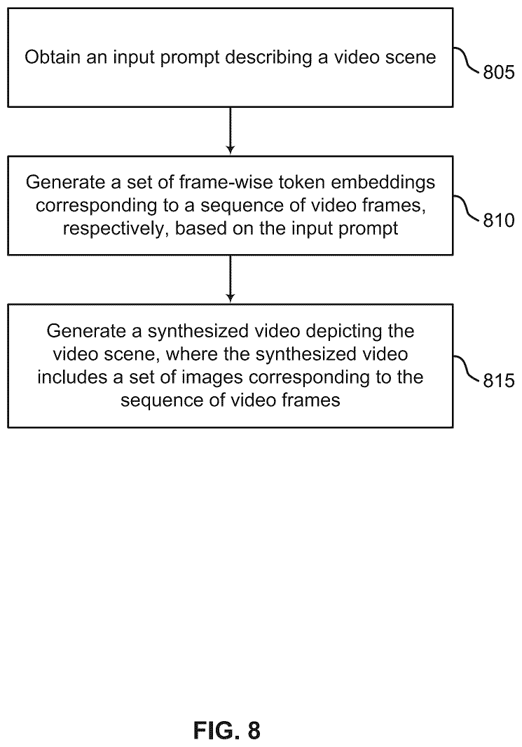

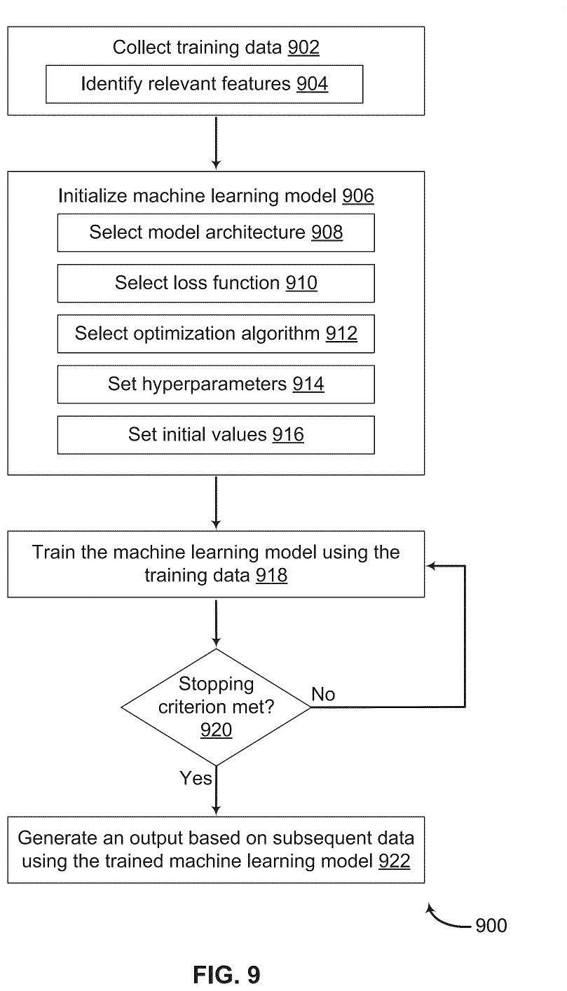

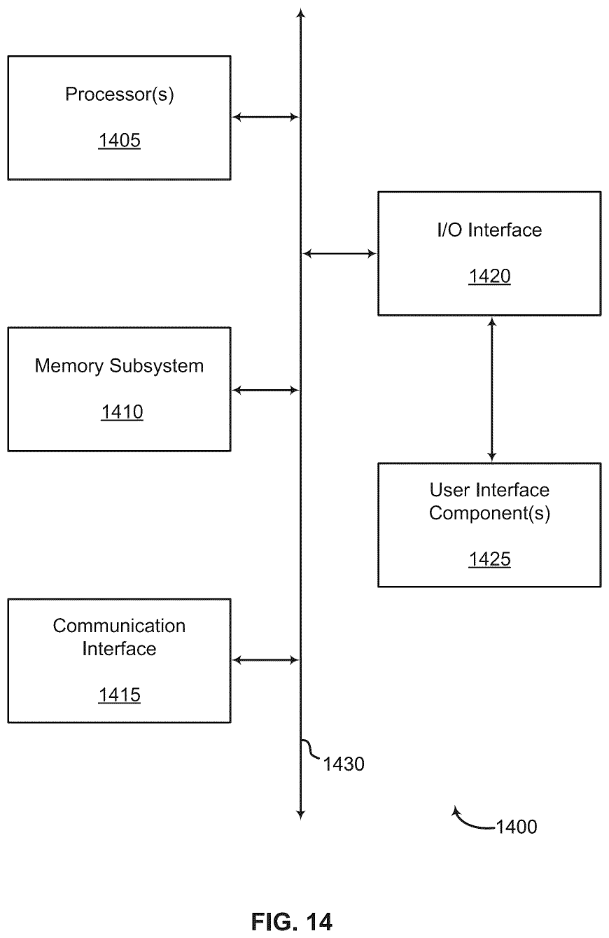

A video processing system is described with FIGS. 1-6. Methods for generating synthetic videos are described with reference to FIGS. 7-8. Methods for training a video generation model are described with reference to FIGS. 9-13. A computing device configured to implement a video processing apparatus is described with reference to FIG. 14

### Video Processing System

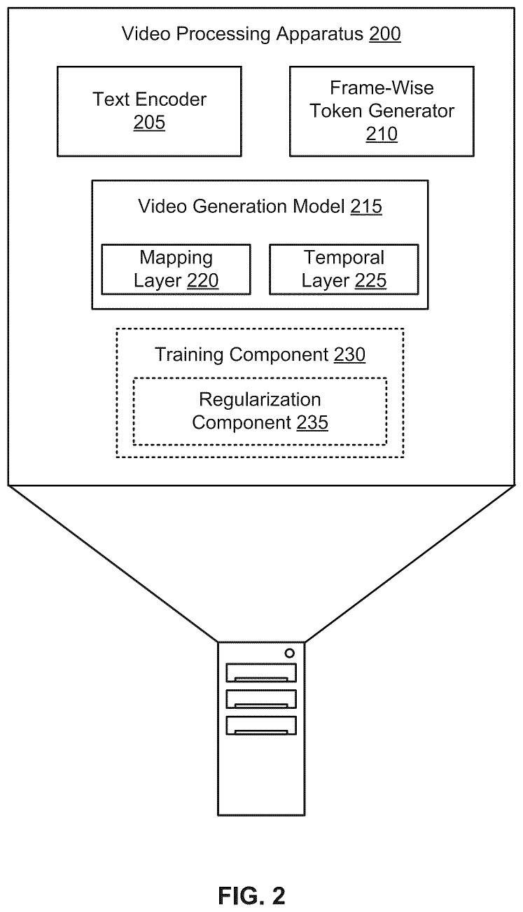

FIG. 1 shows an example of a video processing system according to aspects of the present disclosure. The example shown includes video processing apparatus 100, database 105, network 110, and user interface 115. Video processing apparatus 100 is an example of, or includes aspects of, the corresponding element described with reference to FIG. 2.

In an example use case, a user provides a text prompt as input to the system via user interface 115. The text prompt includes a description of content the user wishes to generate, such as a character or an object. In the example shown, the text prompt is “a dog playing.” Some embodiments encode the text prompt to create a text embedding, and then add frame-wise token embeddings to the text embedding so that each frame of the video can be generated with a unique set of features. Then, the video processing apparatus generates a synthetic video based on the text prompt, and then outputs the video back to the user via user interface 115.

In some embodiments, one or more components of video processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the video processing system. For example, database 105 may store training data, model parameters, previously generated videos, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between video processing apparatus 100, database 105, and a user, e.g., via user interface 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with the video processing apparatus 100. For example the user may enter a text prompt, instruct the system to generate a video, and view the video via user interface 115. In some embodiments, the user interface 115 may include an audio device, such as an external speaker system, an external display device such as a display screen, or an input device (e.g., remote control device interfaced with the user interface 115 directly or through an IO controller module). In some cases, a user interface 115 may be a graphical user interface 115 (GUI). For example, the GUI may be incorporated as part of a web application.

FIG. 2 shows an example of a video processing apparatus 200 according to aspects of the present disclosure. The example shown includes video processing apparatus 200, text encoder 205, frame-wise token generator 210, video generation model 215, and training component 230.

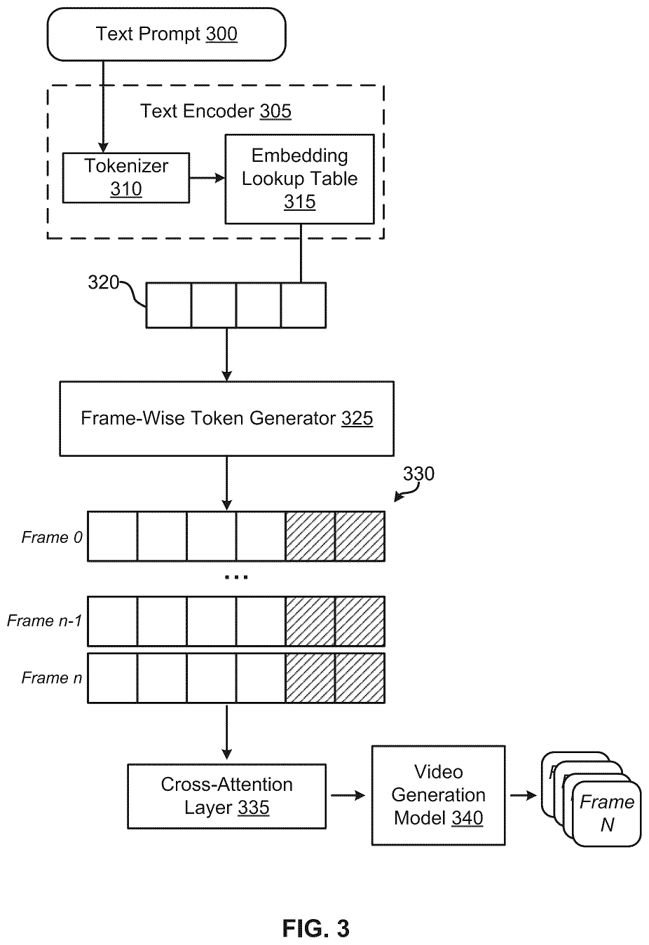

Video processing apparatus 200 is an example of, or includes aspects of, the corresponding element described with reference to FIG. 1. Text encoder 205 is an example of, or includes aspects of, the corresponding element described with reference to FIG. 3. Frame-wise token generator 210 is an example of, or includes aspects of, the corresponding element described with reference to FIG. 3.

The video processing apparatus 200 described herein may include several components. These components are variously named and are described so as to partition the functionality enabled by the processor(s) and the executable instructions included in the computing devices used to implement the apparatuses (such as the computing device described with reference to FIG. 14). In some examples, the partitions are implemented physically, such as through the use of separate circuits or processors for each component. In some examples, the partitions are implemented logically via the architecture of the code executable by the processors.

Video processing apparatus 200 includes components that may be implemented using one or more artificial neural networks (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process of the ANN, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Text encoder 205 encodes an input text prompt to obtain a text embedding, which may comprise a plurality of token embeddings. Embodiments of text encoder 205 include a transformer-based model, such as Flan-T5 or GPT-2. Additional details regarding the text encoder 205 will be provided with reference to FIG. 3.

Frame-wise token generator 210 generates a set of frame-wise token embeddings corresponding to a sequence of video frames, respectively, based on an input text prompt. In some examples, frame-wise token generator 210 generates one or more frame-specific embeddings for each of the sequence of video frames, respectively, based on the plurality of token embeddings generated by text encoder 205. Some embodiments of frame-wise token generator 210 include a multi-layer perceptron network (MLP) with an output layer of the same dimensionality as the text token embeddings (for example, 768). Additional detail regarding the frame-wise token generator 210 will be provided with reference to FIG. 3.

Video generation model 215 generates a synthetic video based on a text prompt. Embodiments of video generation model 215 include an image generation model such as a diffusion model that is adapted with additional layers and finetuned on video data. For example, embodiments of video generation model 215 include a diffusion model with a mapping layer (also referred to herein as a “mapping network”) placed in front of a U-Net architecture, as well as temporal layers placed at different blocks of the U-Net.

According to some aspects, video generation model 215 generates a synthesized video depicting a video scene described by a text prompt, where the synthesized video includes a set of images corresponding to a sequence of video frames. In some examples, video generation model 215 performs a cross-attention operation based on an intermediate representation and a corresponding a frame-wise token embedding of the set of frame-wise token embeddings. In some examples, video generation model 215 performs a diffusion process using the set of frame-wise token embeddings as guidance. In some examples, video generation model 215 obtains a set of noise inputs corresponding to the sequence of video frames, respectively. In some examples, video generation model 215 generates a preliminary noise prediction. In some aspects, the video generation model 215 is trained using a temporal consistency loss. Video generation model 215 is an example of, or includes aspects of, the corresponding element described with reference to FIG. 3.

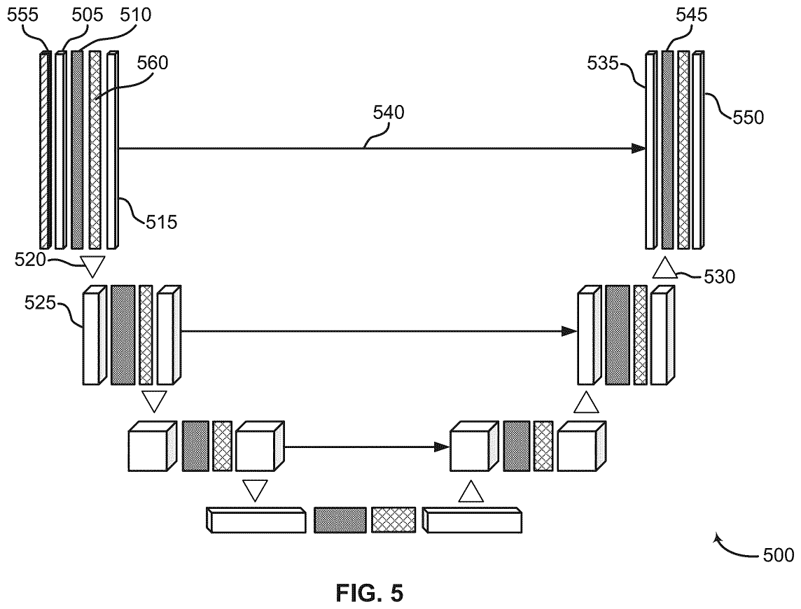

In one aspect, video generation model 215 includes mapping layer 220 and temporal layer 225. Mapping layer 220 transforms an initial Gaussian noise distribution into a distribution that is more suitable for generating videos. This transformation allows the diffusion model to maintain stable training while still leveraging the reparameterization trick used during training ANNs. Embodiments of mapping layer 220 include an ANN which helps capture the relationships between frames and ensure that the generated video maintains coherence across time. In this way, mapping layer 220 prepares the input noise (or noise latents) for the video generation process. Mapping layer 220 is an example of, or includes aspects of, the corresponding element described with reference to FIG. 5.

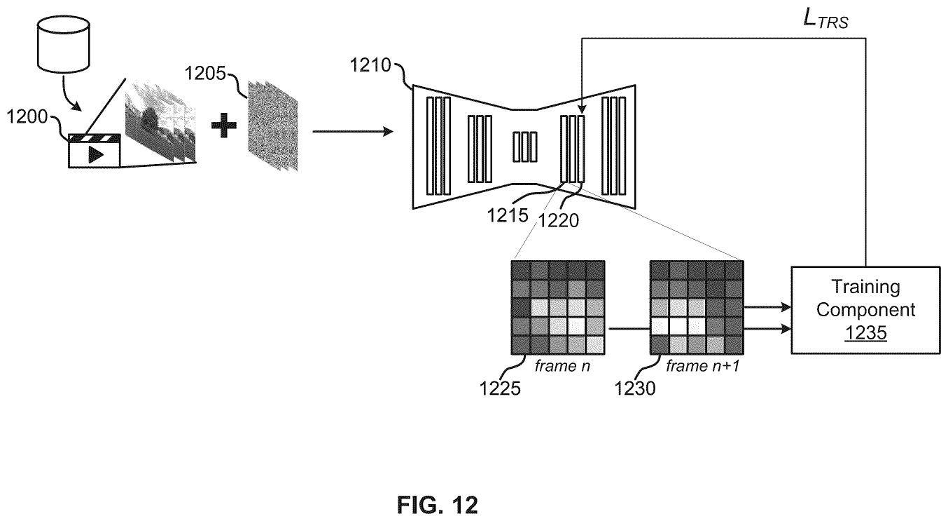

Temporal layer 220 maintains temporal coherence between frames generated by video generation model 215. This layer may include temporal attention mechanisms, feed forward network(s), or other components that ensure consistency in object positioning, lighting, and motion across frames. Temporal layer 225 helps to smooth out transitions between frames, reducing the risk of artifacts such as flickering or blurring. Temporal layer 225 is an example of, or includes aspects of, the corresponding element described with reference to FIGS. 5 and 12.

Training component 230 updates parameters of video generation model 215 by comparing outputs of video generation model to ground-truth training data, which may include videos. According to some aspects, training component 230 computes a temporal consistency loss based on the video and the training prompt. The temporal consistency loss may be based on, for example, differences in attention maps between adjacent generated samples (frames). In some examples, training component 230 trains a video generation model 215 to generate a synthesized video from an input prompt based on the temporal consistency loss.

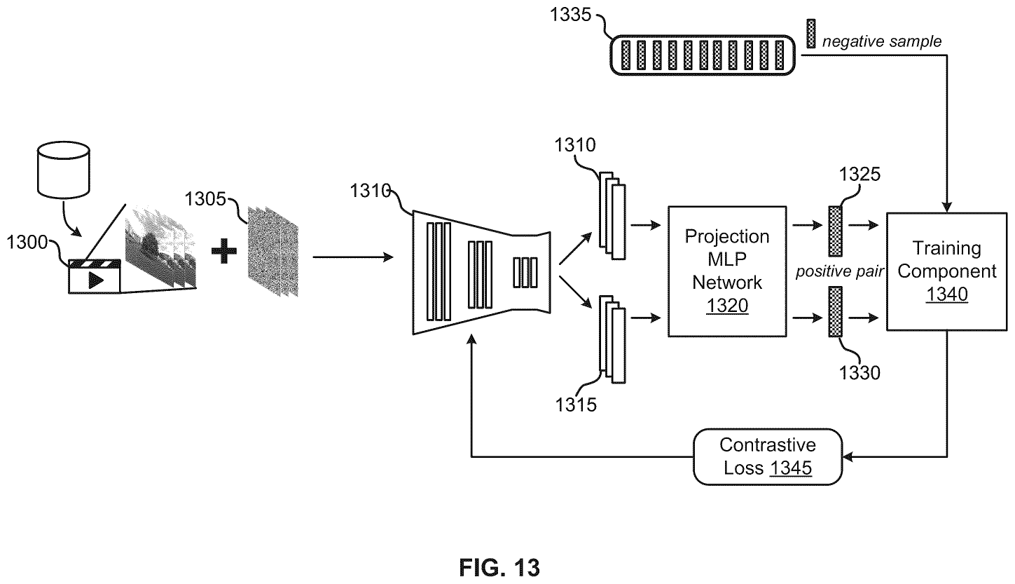

In some examples, training component 230 obtains a positive sample including two video frames of the video. In some examples, training component 230 obtains a negative sample including a first video frame of the video and a second video frame from a different video, where the temporal consistency loss is based on the positive sample and the negative sample. In some examples, training component 230 projects representations from a bottleneck layer of the video generation model 215 for each frame of the positive sample and the negative sample into a projection space. In some examples, training component 230 computes a contrastive loss based on the projection. Additional detail regarding these training paradigms is provided with reference to FIGS. 12-13. In at least one embodiment, training component 230 is implemented on an apparatus other than video processing apparatus 200.

In one aspect, training component 230 includes regularization component 235. Regularization component 235 is configured to compute regularization losses that are used during training. For example, regularization component 235 computes a regularization loss that prevents the video generation model 215 from straying too far from the expertise of its pretraining (e.g., for image generation). An example of this loss is given by Equation (1):

$${L}_{reg} = {λ}_{c} {‖ {f}_{θ , Φ} ( {x}_{t} , t , c ) - {f}_{Φ} ( {x}_{t} , t , c ) ‖}_{2}^{2} \qquad ( 1 )$$

where f_{θ,ϕ(·)} denotes the entire video generation model including temporal layers and f_{ϕ} denotes the parent image generation model (e.g., with the mapping layer 220 but without the temporal layers. Regularization component 235 also computes a regularized self-attention loss based on spatial attention signals that will be described in greater detail with reference to FIG. 12.

FIG. 3 shows an example of a frame-wise token generator 325 according to aspects of the present disclosure. The example shown includes text prompt 300, text encoder 305, text embedding 320, frame-wise token generator 325, combined embedding 330, cross-attention layer 335, and video generation model 340.

Text encoder 305 is an example of, or includes aspects of, the corresponding element described with reference to FIG. 2. Frame-wise token generator 325 is an example of, or includes aspects of, the corresponding element described with reference to FIG. 2. Video generation model 340 is an example of, or includes aspects of, the corresponding element described with reference to FIG. 2.

In this example, the system obtains a text prompt 300 that is encoded by text encoder 305 to obtain text embedding 320. In some embodiments, the text embedding 320 is positioned in an embedding space of size (M× D), where M denotes maximum token length (e.g., 77) and D denotes token embedding dimension (e.g., 768).

In one aspect, text encoder 305 includes tokenizer 310 and embedding lookup table 315. The tokenizer 310 splits the text prompt into individual tokens, which are typically words or subwords. The tokenizer 310 may do this by applying predefined rules or models that break down the text into smaller components. The embedding lookup table 315 then converts these tokens into corresponding embeddings. The embedding lookup table 315 may store pre-trained embeddings for a large vocabulary of tokens, each represented as a vector in the embedding space. The initial embeddings represent the semantic meaning of the tokens in a format that can be processed by a downstream model.

Text embedding 320 is then input to frame-wise token generator 325, which generates combined embedding 330 therefrom. Combined embedding 330 includes the additional frame-wise tokens. The combined embeddings for all frames of the video may be of the shape (F×FW×D), where F denotes the number of frames, and FW denotes the number of frame-wise tokens. The example shown includes 2 frame-wise tokens per frame, though embodiments are not limited thereto and may include 1 or 3 or more frame-wise tokens per frame. The frame-wise tokens represent varying details across frames, allowing the system to introduce slight differences in the conditions for generating each frame. By including these frame-wise tokens, the model ensures that each frame is not generated with the same exact condition as the other frames, which helps to capture temporal variations and dynamic changes throughout the video. According to same aspects, the inclusion of frame-wise tokens induces diverse movements and other natural variations in the generated videos.

Cross-attention layer 335 makes adjustments to the combined embeddings by considering all of the tokens in each embedding using a cross-attention mechanism. The cross-attention layer 335 links the information from the text with the varying details captured by the frame-wise tokens, allowing the model to generate frames that are contextually consistent with the text prompt while also reflecting the frame-specific variations. The output of cross-attention 335 is then used as conditioning for the generative process performed by video generation model 340.

In some embodiments, the frame-wise token generator 325 (also denoted as the (·)) is trained by a training component such as the one described with reference to FIG. 2. For example, given a text embedding c, the training component obtains the overall condition c by computing c=concat(c.repeat(f,1),t_{θ}(c)), and associating these condition features with the ground-truth training data during the denoising process.

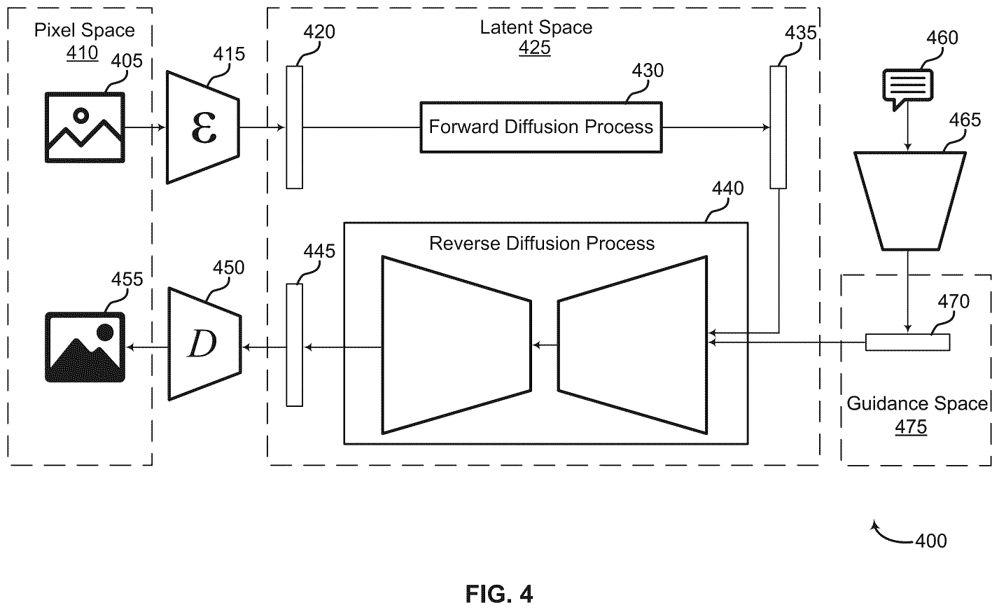

FIG. 4 shows an example of a guided latent diffusion model 400 according to aspects of the present disclosure. The guided latent diffusion model 400 depicted in FIG. 4 is an example of, or includes aspects of, the video generation model described with reference to FIG. 4.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 400 may take an original image 405 in a pixel space 410 as input and apply and image encoder 415 to convert original image 405 into original image features 420 in a latent space 425. Then, a forward diffusion process 430 gradually adds noise to the original image features 420 to obtain noisy features 435 (also in latent space 425) at various noise levels.

Next, a reverse diffusion process 440 (e.g., a U-Net ANN) gradually removes the noise from the noisy features 435 at the various noise levels to obtain denoised image features 445 in latent space 425. In some examples, the denoised image features 445 are compared to the original image features 420 at each of the various noise levels, and parameters of the reverse diffusion process 440 of the diffusion model are updated based on the comparison. Finally, an image decoder 450 decodes the denoised image features 445 to obtain an output image 455 in pixel space 410. In some cases, an output image 455 is created at each of the various noise levels. The output image 455 can be compared to the original image 405 to train the reverse diffusion process 440.

In some cases, image encoder 415 and image decoder 450 are pre-trained prior to training the reverse diffusion process 440. In some examples, they are trained jointly, or the image encoder 415 and image decoder 450 and fine-tuned jointly with the reverse diffusion process 440.

The reverse diffusion process 440 can also be guided based on a text prompt 460, or another guidance prompt, such as an image, frame-wise tokens, a layout, a segmentation map, etc. The text prompt 460 can be encoded using a text encoder 465 (e.g., a multimodal encoder) to obtain guidance features 470 (such as the combined embedding(s) described with reference to FIG. 3) in guidance space 475. The guidance features 470 can be combined with the noisy features 435 at one or more layers of the reverse diffusion process 440 to ensure that the output image 455 includes content described by the text prompt 460. For example, guidance features 470 can be combined with the noisy features 435 using a cross-attention block within the reverse diffusion process 440.

FIG. 5 shows an example of a U-Net 500 according to aspects of the present disclosure. In some examples, U-Net 500 is an example of the component that performs the reverse diffusion process 440 of guided diffusion model 400 described with reference to FIG. 4 and includes architectural elements of the video generation model 215 described with reference to FIG. 2. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having the same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

Mapping layer 555 transforms an initial Gaussian noise distribution into a distribution that is more suitable for generating videos. This transformation allows the diffusion model to maintain stable training while still leveraging the reparameterization trick used during training ANNs. Embodiments of mapping layer 555 include an ANN which helps capture the relationships between frames and ensure that the generated video maintains coherence across time. In this way, mapping layer 220 prepares the input noise (or noise latents) for the video generation process is an example of, or includes aspects of, the corresponding element described with reference to FIG. 2.

Temporal layer 560 maintains temporal coherence between frames generated by U-Net FIG. 5. This layer may include temporal attention mechanisms, feed forward network(s), or other components that ensure consistency in object positioning, lighting, and motion across frames. Temporal layer 560 helps to smooth out transitions between frames, reducing the risk of artifacts such as flickering or blurring. Temporal layer 560 is an example of, or includes aspects of, the corresponding element described with reference to FIGS. 2 and 12.

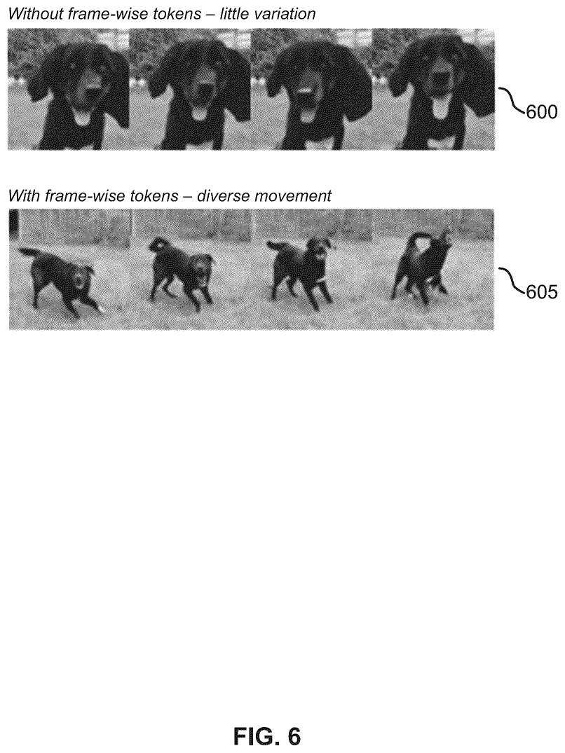

FIG. 6 shows an example of results using frame-wise tokens according to aspects of the present disclosure. The example shown includes output without frame-wise tokens 600 and output with frame-wise tokens 605.

As apparent from FIG. 6, the output without frame-wise tokens 600 has very little variation across frames. The video depicts a close-up view of a dog staring at a camera for the entirety of the video.

In contrast, output with frame-wise tokens 605 has significant variation across its frames, particularly in movement. Output with frame-wise tokens 605 depicts a dog jumping around in his/her environment and letting out a bark near the end.

### Generating Synthetic Videos

FIG. 7 shows a diffusion process 700 according to aspects of the present disclosure. In some examples, diffusion process 700 describes an operation of the video generation model 215 described with reference to FIG. 2, such as the reverse diffusion process 440 of guided diffusion model 400 described with reference to FIG. 4. According to some aspects, the video generation model performs a reverse diffusion process conditioned on combined embeddings (i.e., frame-wise embeddings) to generate frames of a video.

As described above with reference to FIG. 4, using a diffusion model can involve both a forward diffusion process 705 for adding noise to an image (or features in a latent space) and a reverse diffusion process 710 for denoising the images (or features) to obtain a denoised image. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate images with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 710, the model begins with noisy data x_{T}, such as a noisy image 715 and denoises the data to obtain the p(xₜ₋₁|xₜ). At each step t−1, the reverse diffusion process 710 takes xₜ, such as first intermediate image 720, and t as input. Here, t represents a step in the sequence of transitions associated with different noise levels, The reverse diffusion process 710 outputs xₜ₋₁, such as second intermediate image 725 iteratively until x_{T} reverts back to x₀, the original image 730. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) \qquad ( 2 )$$

The joint probability of a sequence of samples in the Markov chain can be written as a product of conditionals and the marginal probability:

$${x}_{T} : {p}_{θ} ( {x}_{0 : τ} ) : = p ( {x}_{T} ) {π}_{t = 1}^{T} {p}_{θ} ( {x}_{t - 1} \vert {x}_{t} ) \qquad ( 3 )$$

where p(x_{T})=N(x_{T};0,I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

In some cases, even with a well-trained model, some video outputs may exhibit artifacts that appear or disappear. Accordingly, some embodiments add an additional “mitigating gradient sampling” guidance during the inference process. This is based on the classical technique of classifier-free guidance (CFG), which is represented by the following equation for diffusion models performing the reverse diffusion process with a guidance Φ:

$$dx = [ - f ( x , {t}^{′} ) + {g ( {t}^{′} )}^{2} ( {s}_{θ} ( x , {t}^{′} ) + α {∇}_{x} log {Φ}_{t} ) ] dt + g ( {t}^{′} ) dw \qquad ( 4 )$$

where t′=T−t and signifies the reverse timestep, and α is a parameter that scales the guidance. Embodiments implement a mitigating gradient sampling approach expressed by the following equation:

$${∇}_{{x}_{i}} log {Φ}_{t} ( x ) ← {∇}_{{x}_{i}} ω {\sum }_{j = 2}^{F} exp ( - \frac{{‖ - {( j - 1 )}^{} ‖}^{2}}{2 {σ}^{2}} ) \qquad ( 5 )$$

where [symbol] ⁽ⁱ⁾ denotes predicted x₀ of frame i at timestep t. The mitigating gradient sampling log Φₜ iteratively reduces the differences between frames during inference. In some cases, if the synthesized video already has smooth differences between frames, then the impact of mitigating gradient sampling is minimal. An algorithm for implementing the mitigating gradient sampling is given by Algorithm 1:

Algorithm 1: Mitigating Gradient Sampling

| | |
|---|---|
| 1 | ϵ_{pred}= s_{θ}(xₜ, Ø) + ω_{CFG} (s_{θ}(xₜ, c) − s_{θ}(xₜ, Ø)) |
| 2 | [symbol] ← \hat{x}ₜ[1 :] − \hat{x}ₜ[: −1] |
| 3 | [symbol] ← norm( [symbol] , 2). median( )²/log(F − 1) |
| 4 | [symbol] _{ϕ} ← 2 · exp(−( norm( [symbol] , 2)²/ [symbol] )) · [symbol] /S · ω |
| 5 | ϵ_{pred}←ϵ_{pred}+ α · concat(0, [symbol] _{ϕ}) |

where [symbol] denotes [symbol] ^{j}− [symbol] ^{(j-1)} from Equation (5), [symbol] denotes 2σ², [symbol] _{ϕ} denotes the closed form of

$${∇}_{{x}_{i}} ω {\sum }_{j = 2}^{F} exp ( - \frac{{‖ - ‖}^{2}}{2 {σ}^{2}} ) ,$$

α is the strength of [symbol] _{ϕ}, and ∈_{pred} is the predicted noise vector used to denoise the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

FIG. 8 shows an example of a method 800 for generating synthesized video according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains an input prompt describing a video scene. In some cases, the operations of this step refer to, or may be performed by, a video processing apparatus as described with reference to FIGS. 1 and 2. A user may provide the input prompt via, for example, a GUI as described with reference to FIG. 2.

At operation 810, the system generates a set of frame-wise token embeddings corresponding to a sequence of video frames, respectively, based on the input prompt. In some cases, the operations of this step refer to, or may be performed by, a frame-wise token generator as described with reference to FIGS. 2 and 3. The frame-wise token embeddings encode visual information on a per-frame basis that induces variation between frames of a generated video. Additional detail regarding the frame-wise token generator and the combined condition it generates is provided with reference to FIG. 3.

At operation 815, the system generates, using a video generation model, a synthesized video depicting the video scene, where the synthesized video includes a set of images corresponding to the sequence of video frames. In some cases, the operations of this step refer to, or may be performed by, a video generation model as described with reference to FIGS. 2 and 3. The video generation model may be based on, for example, a guided latent diffusion model as described with reference to FIGS. 4-5. The video generation model may generate the video by performing repeated operations of a reverse diffusion process as described with reference to FIG. 7. The reverse diffusion process may be further guided by a mitigating gradient sampling guidance as described with reference to Equations (4)-(5) and Algorithm 1.

### Training Methods

FIG. 9 is a flow diagram depicting an algorithm as a step-by-step procedure 900 in an example implementation of operations performable for training a machine-learning model. In some embodiments, the procedure 900 describes an operation of the training component 230 described for configuring the video generation model 215 as described with reference to FIG. 2. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model.

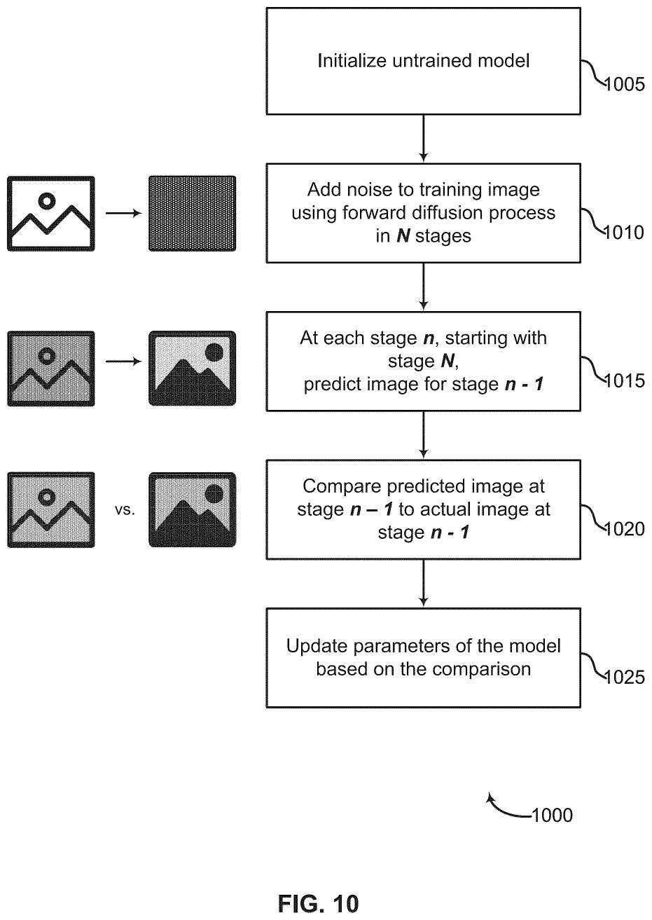

FIG. 10 shows an example of a method 1000 for training a diffusion model according to aspects of the present disclosure. In some embodiments, the method 1000 describes an operation of the training component 225 described for configuring the video generation model 815 as described with reference to FIG. 2. The method 1000 represents an example for training a reverse diffusion process as described above with reference to FIG. 7. In some examples, these operations are performed by a system including a processor executing a set of codes to control functional elements of an apparatus, such as the guided diffusion model described in FIG. 4.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

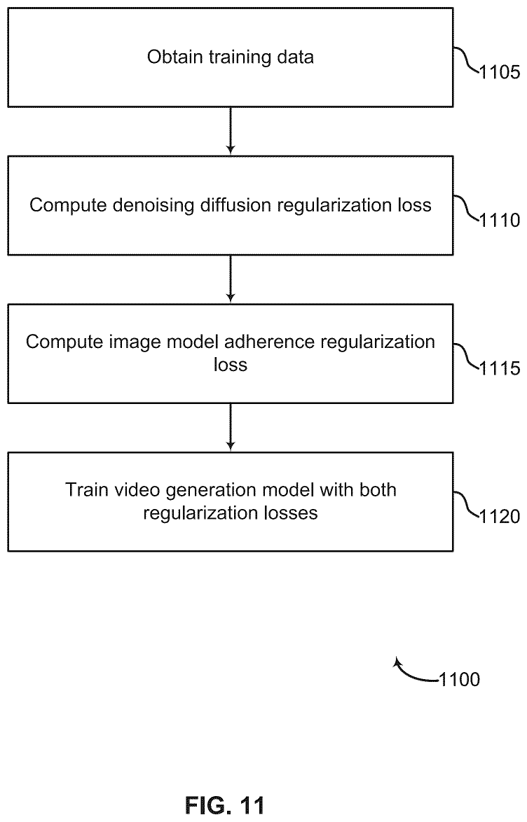

FIG. 11 shows an example of a method 1100 for regularizing the training of a video generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains training data. The training data may include, for example, video data with corresponding captions.

At operation 1110, the system computes denoising diffusion regularization loss. The denoising diffusion regularization loss may be a score matching loss that can be expressed as, for example:

$${L}_{simple} = {t , {x}_{0 ,} ϵ}_{} {\vert ϵ - {s}_{θ} ( {x}_{t} , t ) \vert}_{2}^{2} \qquad ( 6 )$$

where s_{θ}(xₜ,t) is the prediction of the diffusion model at timestep t.

At operation 1115, the system computes image model adherence regularization loss. This loss regularizes the training process so that the video generation model doesn't lose the knowledge of the pre-trained image generation model. An example formulation of this loss is given by L_{reg} from Equation (1).

At operation 1120, the system trains video generation model with both regularization losses. The system may do so, for example, via a training component as described with reference to FIG. 2. The training component may update parameters of the video generation model via gradient descent using the aforementioned loss functions.

FIG. 12 shows an example of a first pipeline for training a video generation model according to aspects of the present disclosure. The example shown includes training data 1200, initial noise latents 1205, U-Net 1210, attention map 1225, adjacent attention map 1230, and training component 1235.

U-Net 1210 is an example of, or includes aspects of, the corresponding element described with reference to FIG. 5. Temporal layer 1220 is an example of, or includes aspects of, the corresponding element described with reference to FIGS. 2 and 5. Training component 1235 is an example of, or includes aspects of, the corresponding element described with reference to FIGS. 2 and 13.

Embodiments train a U-Net using training data 1200 according to the processes described in greater detail with reference to FIG. 10. During training, embodiments utilize a temporal regularized self-attention loss. The temporal regularized self-attention loss L_{TRS}, which regularizes the temporal-wise variant of self-attention maps, may be expressed as:

$${L}_{TRS} = {\sum }_{l} {\sum }_{i = 2}^{F} {λ}_{l} \vert {A}_{l}^{( i )} - {A}_{l}^{( i - 1 )} \vert \qquad ( 7 )$$

where Aₗ(i) (denotes l-th layer self-attention map of the i-th frame. The self-attention maps are associated with generating objects and structure. Accordingly, L_{TRS}, which penalizes rapid changes in self-attention maps, enforces smooth changes between frames of a video. In some embodiments, system uses

$${λ}_{l} = \frac{1}{N} ,$$

where l∈{1, . . . , N} and l layers are chosen from the decoder of U-Net. Embodiments calculate L_{TRS} at the self-attention maps inside the spatial layers and update the temporal layers with L_{TRS}. In some cases, the L_{TRS} is used for training the decoder part of U-Net, while other parameters of the U-Net are held fixed.

FIG. 13 shows an example of a second pipeline for training a video generation model according to aspects of the present disclosure. The example shown includes training data 1300, initial noise latents 1305, first deep feature 1310, second deep feature 1315, projection MLP network 1320, first projected feature 1325, second projected feature 1330, negative sample queue 1335, training component 1340, and contrastive loss 1345. Training component 1340 is an example of, or includes aspects of, the corresponding element described with reference to FIGS. 2 and 12.

According to some aspects, the deepest features of a U-Net architecture (referred to sometimes as the “h-space”) contain rich semantic representations of the content in a video frame, regardless of the iterative timestep t. Therefore, some embodiments train the video generation model using a loss that constrains all frames of a generated video to have similar h features, referred to as a “decoupled contrastive loss.”

Embodiments obtain first deep feature 1310 and second deep feature 1315 from the lowest spatial dimension block of the U-Net and utilize projection MLP network 1320 to generate first projected feature 1325 and second projected feature 1330 therefrom, respectively. Using mathematical notation, the projection network g_{θ}(·) computes projected features z=g_{θ}(h). According to some aspects, the projected features are more computationally efficient to compare when computing the loss. The decoupled contrastive loss, obtained by comparing the pairs, may be expressed as:

$${L}_{D C} = - \frac{〈 {z}^{( 1 )} , {z}^{( 2 )} 〉}{τ} + log {\sum }_{q ϵ Q} exp ( 〈 \frac{{z}^{( 1 )} , {z}^{( q )}}{τ} 〉 ) \qquad ( 8 )$$

where z⁽¹⁾, z⁽²⁾ are projected positive pairs, and z⁽¹⁾, z^{(q)} are negative pairs, the negative sample being obtained from negative queue Q (negative sample queue 1335) which holds frames from other videos. The decoupled contrastive loss L_{DC} encourages frames in a video to be closer together in h-space while pushing dissimilar frames from other videos apart. The positive pairs can contain non-consecutive frames because h-space does not represent the structure of the scene, but rather semantic information (e.g., does this content contain a “lion”, “grass”, and the like).

Accordingly, training component may train all components of the video generation network, including the mapping layer, the temporal layers, the projection network used in computing the contrastive loss, and the frame-wise token generator according to a combined loss as follows:

$${L}_{all} ( θ ) = {L}_{simple} + {λ}_{TRS} {L}_{TRS} + {λ}_{reg} {L}_{reg} + {λ}_{contrastive} {L}_{constrastive} \qquad ( 9 )$$

Note that, in some embodiments, Lₛᵢₘₚₗₑ is not computed for adjustments to f_{Φ}(xₜ,t,c), that is the video generation model without the temporal layers, but with the mapping layer. According to some aspects, the projection network is discarded after training.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, video processing apparatus 100 of FIG. 1. In some embodiments, computing device 1400 includes one or more processors 1405 are configured to execute instructions stored in memory subsystem 1410 to obtain an input prompt describing a video scene; generate a plurality of frame-wise token embeddings corresponding to a sequence of video frames, respectively, based on the input prompt; and generate, using a video generation model, a synthesized video depicting the video scene, wherein the synthesized video comprises a plurality of images corresponding to the sequence of video frames.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI, such as the one described with reference to FIG. 2.

Accordingly, the present disclosure includes the following aspects. A method for video generation is described. One or more aspects of the method include obtaining an input prompt describing a video scene; generating a plurality of frame-wise token embeddings corresponding to a sequence of video frames, respectively, based on the input prompt; and generating, using a video generation model, a synthesized video depicting the video scene, wherein the synthesized video comprises a plurality of images corresponding to the sequence of video frames. In some aspects, the video generation model is trained using a temporal consistency loss.

Some examples of the method, apparatus, non-transitory computer readable medium, and system further include encoding the input prompt to obtain a plurality of token embeddings. Some examples further include generating one or more frame-specific embeddings for each of the sequence of video frames, respectively, based on the plurality of token embeddings. Some examples further include combining the plurality of token embeddings with the one or more frame-specific embeddings for each of the sequence of video frames to obtain the plurality of frame-wise token embeddings.

Some examples of the method, apparatus, non-transitory computer readable medium, and system further include performing a cross-attention operation based on an intermediate representation and a corresponding a frame-wise token embedding of the plurality of frame-wise token embeddings. Some examples further include performing a diffusion process using the plurality of frame-wise token embeddings as guidance.

Some examples of the method, apparatus, non-transitory computer readable medium, and system further include obtaining a plurality of noise inputs corresponding to the sequence of video frames, respectively. Some examples further include generating a plurality of regularized noise inputs based on the plurality of noise inputs, respectively, wherein the plurality of regularized noise inputs have a temporally regularized distribution.

Some examples of the method, apparatus, non-transitory computer readable medium, and system further include generating a preliminary noise prediction. Some examples further include generating a temporally regularized noise prediction based on the preliminary noise prediction and one or more temporally adjacent noise predictions.

A method for training a machine learning model is described. One or more aspects of the method include obtaining a training set comprising a video and a training prompt describing the video; computing a temporal consistency loss based on the video and the training prompt; and training a video generation model to generate a synthesized video from an input prompt based on the temporal consistency loss.

Some examples of the method, apparatus, non-transitory computer readable medium, and system further include computing a difference in self-attention maps across video frames, wherein the temporal consistency loss is based on the difference. Some examples further include obtaining a positive sample including two video frames of the video. Some examples further include obtaining a negative sample including a first video frame of the video and a second video frame from a different video, wherein the temporal consistency loss is based on the positive sample and the negative sample.

Some examples of the method, apparatus, non-transitory computer readable medium, and system further include projecting representations from a bottleneck layer of the video generation model for each frame of the positive sample and the negative sample into a projection space. Some examples further include computing a contrastive loss based on the projection.

Some examples of the method, apparatus, non-transitory computer readable medium, and system further include generating a plurality of frame-wise token embeddings corresponding to a sequence of video frames, respectively, based on the training prompt, wherein the temporal consistency loss is generated based on the plurality of frame-wise token embeddings. Some examples further include obtaining a plurality of noise inputs corresponding to a sequence of video frames, respectively. Some examples further include generating a plurality of regularized noise inputs based on the plurality of noise inputs, respectively, wherein the plurality of regularized noise inputs have a temporally regularized distribution, and wherein the temporal consistency loss is generated based on the plurality of regularized noise inputs.

Some examples of the method, apparatus, non-transitory computer readable medium, and system further include generating a preliminary noise prediction. Some examples further include generating a temporally regularized noise prediction based on the preliminary noise prediction and one or more temporally adjacent noise predictions, wherein the temporal consistency loss is generated based on the temporally regularized noise prediction.

An apparatus for video generation is described. One or more aspects of the apparatus include at least one processor; at least one memory including instructions executable by the at least one processor; and a video generation model comprising parameters stored in the at least one memory and trained to generate a synthesized video based on an input prompt, wherein the video generation model includes a mapping network configured to generate a plurality of regularized noise inputs based on a plurality of noise inputs, respectively, and wherein the plurality of regularized noise inputs have a temporally regularized distribution.

Some examples of the apparatus, system, and method further include a text encoder configured to encode the input prompt to obtain a plurality of token embeddings. Some examples of the apparatus, system, and method further include a frame-wise token generator configured to generate a plurality of frame-wise token embeddings corresponding to a sequence of video frames.

In some aspects, the video generation model includes a diffusion model. In some aspects, the video generation model is trained using a temporal consistency loss based on a training video and a training prompt. In some aspects, the video generation model generates the synthesized video using a temporally regularized noise prediction.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing a video scene;
generating a plurality of frame-wise token embeddings corresponding to a sequence of video frames, respectively, based on the input prompt; and
generating, using a video generation model, a synthesized video depicting the video scene, wherein the synthesized video comprises a plurality of images corresponding to the sequence of video frames.

2. The method of claim 1, wherein generating the plurality of frame-wise token embeddings comprises:
encoding the input prompt to obtain a plurality of token embeddings;
generating one or more frame-specific embeddings for each of the sequence of video frames, respectively, based on the plurality of token embeddings; and
combining the plurality of token embeddings with the one or more frame-specific embeddings for each of the sequence of video frames to obtain the plurality of frame-wise token embeddings.

3. The method of claim 1, wherein generating the synthesized video comprises:
performing a cross-attention operation based on an intermediate representation and a corresponding a frame-wise token embedding of the plurality of frame-wise token embeddings.

4. The method of claim 1, wherein generating the synthesized video comprises:
performing a diffusion process using the plurality of frame-wise token embeddings as guidance.

5. The method of claim 1, wherein generating the synthesized video comprises:
obtaining a plurality of noise inputs corresponding to the sequence of video frames, respectively; and
generating a plurality of regularized noise inputs based on the plurality of noise inputs, respectively, wherein the plurality of regularized noise inputs have a temporally regularized distribution.

6. The method of claim 1, wherein generating the synthesized video comprises:
generating a preliminary noise prediction; and
generating a temporally regularized noise prediction based on the preliminary noise prediction and one or more temporally adjacent noise predictions.

7. The method of claim 1, wherein:
the video generation model is trained using a temporal consistency loss.

8. A method for training a machine learning model, the method comprising:
obtaining a training set comprising a video and a training prompt describing the video;
computing a temporal consistency loss based on the video and the training prompt; and
training a video generation model to generate a synthesized video from an input prompt based on the temporal consistency loss.

9. The method of claim 8, wherein computing the temporal consistency loss comprises:
computing a difference in self-attention maps across video frames, wherein the temporal consistency loss is based on the difference.

10. The method of claim 8, wherein computing the temporal consistency loss comprises:
obtaining a positive sample including two video frames of the video; and
obtaining a negative sample including a first video frame of the video and a second video frame from a different video, wherein the temporal consistency loss is based on the positive sample and the negative sample.

11. The method of claim 10, wherein computing the temporal consistency loss comprises:
projecting representations from a bottleneck layer of the video generation model for each frame of the positive sample and the negative sample into a projection space; and
computing a contrastive loss based on the projection.

12. The method of claim 8, further comprising:
generating a plurality of frame-wise token embeddings corresponding to a sequence of video frames, respectively, based on the training prompt, wherein the temporal consistency loss is generated based on the plurality of frame-wise token embeddings.

13. The method of claim 8, further comprising:
obtaining a plurality of noise inputs corresponding to a sequence of video frames, respectively; and
generating a plurality of regularized noise inputs based on the plurality of noise inputs, respectively, wherein the plurality of regularized noise inputs have a temporally regularized distribution, and wherein the temporal consistency loss is generated based on the plurality of regularized noise inputs.

14. The method of claim 8, further comprising:
generating a preliminary noise prediction; and
generating a temporally regularized noise prediction based on the preliminary noise prediction and one or more temporally adjacent noise predictions, wherein the temporal consistency loss is generated based on the temporally regularized noise prediction.

15. An apparatus comprising:
at least one processor;
at least one memory including instructions executable by the at least one processor; and
the apparatus further comprising a video generation model comprising parameters stored in the at least one memory and trained to generate a synthesized video based on an input prompt, wherein the video generation model includes a mapping network configured to generate a plurality of regularized noise inputs based on a plurality of noise inputs, respectively, and wherein the plurality of regularized noise inputs have a temporally regularized distribution.

16. The apparatus of claim 15, further comprising:
a text encoder configured to encode the input prompt to obtain a plurality of token embeddings.

17. The apparatus of claim 15, further comprising:
a frame-wise token generator configured to generate a plurality of frame-wise token embeddings corresponding to a sequence of video frames.

18. The apparatus of claim 15, wherein:
the video generation model includes a diffusion model.

19. The apparatus of claim 15, wherein:
the video generation model is trained using a temporal consistency loss based on a training video and a training prompt.

20. The apparatus of claim 15, wherein:
the video generation model generates the synthesized video using a temporally regularized noise prediction.
